(19) United States
(12) Patent Application Publication
(10) Pub. No.: US 2026/0164166 A1
(43) Pub. Date: Jun. 11, 2026

(54) EARPHONES

(71) Applicant: SHENZHEN SHOKZ CO., LTD., Shenzhen (CN)

(72) Inventors: Chaojie CUI, Shenzhen (CN); Sitan CHEN, Shenzhen (CN); Jiang XU, Shenzhen (CN); Haochen LIU, Shenzhen (CN); Lei ZHONG, Shenzhen (CN)

(73) Assignee: SHENZHEN SHOKZ CO., LTD., Shenzhen (CN)

(21) Appl. No.: 19/434,049

(22) Filed: Dec. 29, 2025

Related U.S. Application Data
(63) Continuation of application No. PCT/CN2024/138271, filed on Dec. 10, 2024.

(51) Int. Cl. H04R 1/10; H04R 1/02; H04R 1/08; H04R 9/02

(52) U.S. Cl. CPC H04R 1/1075; H04R 1/02; H04R 1/08; H04R 1/1016; H04R 9/025

(57) ABSTRACT

The present disclosure provides an earphone. The earphone includes a sound generation portion including a first housing, a second housing, and a speaker assembly. The speaker assembly includes an annular support assembly and two sets of vibration assemblies. The two sets of vibration assemblies respectively include protrusion portions protruding beyond the annular support assembly along an axial direction and arranged opposite to each other. The speaker assembly cooperates with the first housing and the second housing to form two first acoustic cavities around two protrusion portions. The annular support assembly has a middle dividing plane perpendicular to the axial direction, and the first housing is provided with two pressure relief holes spaced apart from each other on two sides of the middle dividing plane and respectively connect the corresponding first acoustic cavities with an external environment.

### CROSS-REFERENCE TO RELATED APPLICATIONS

This application is a continuation of International Application No. PCT/CN2024/138271 filed on Dec. 10, 2024, the entire contents of which are incorporated herein by reference.

### TECHNICAL FIELD

The present disclosure relates to the technical field of electronic devices, and in particular, to an earphone.

### BACKGROUND

With the continuous popularization of electronic devices, the electronic devices have become indispensable social and entertainment tools in people's daily lives, leading to increasingly higher demands for the performance of the electronic devices. Electronic devices such as earphones and smart glasses are now extensively integrated into everyday use, functioning in tandem with terminal devices such as smartphones and computers to deliver immersive auditory experiences. Since a pressure relief effect inside the earphones during sound output affects a sound output effect of the earphones, how to improve the pressure relief effect of the earphones is a technical problem that needs to be solved urgently.

### SUMMARY

To solve the above technical problem, one of embodiments of the present disclosure provides an earphone. The earphone includes a sound generation portion, an abutment portion, and an elastic connecting portion connected between the sound generation portion and the abutment portion. In a wearing state, the sound generation portion is disposed in a concha cavity, the abutment portion abuts a back side of an auricle, and the elastic connecting portion is wound around an outer periphery of a helix. The sound generation portion includes a first housing, a second housing, and a speaker assembly. The elastic connecting portion is connected to a first end of the first housing.

The speaker assembly includes an annular support assembly and two sets of vibration assemblies spaced apart from each other along an axial direction of the annular support assembly and disposed on the annular support assembly.

The two sets of vibration assemblies respectively include protrusion portions protruding beyond the annular support assembly along the axial direction and arranged opposite to each other. The speaker assembly cooperates with the first housing and the second housing to form two first acoustic cavities around two protrusion portions. The first housing is provided with two pressure relief holes. The two pressure relief holes are spaced apart from each other, each corresponds to one of the first acoustic cavities and connects the corresponding first acoustic cavity with an external environment.

In some embodiments, the speaker assembly is partially inserted into the first housing from a second end of the first housing along a radial direction perpendicular to the axial direction. The annular support assembly abuts an inner wall surface of the first housing. The second housing is assembled with the second end of the first housing. The first end and the second end are arranged opposite to each other.

Radial sizes of the two protrusion portions are less than a radial size of the annular support assembly. The annular support assembly has a middle dividing plane perpendicular to the axial direction. The two pressure relief holes are spaced apart from each other on two sides of the middle dividing plane.

In some embodiments, the two pressure relief holes are symmetrically arranged with respect to the middle dividing plane.

In some embodiments, the annular support assembly includes a connecting ring and two basket frames. The two sets of vibration assemblies are respectively disposed on the two basket frames. The two basket frames are fixed to two ends of the connecting ring along the axial direction in an assembly manner. The connecting ring abuts the first housing.

In some embodiments, a shortest spacing distance between the two pressure relief holes along the axial direction is not less than a width of the connecting ring.

In some embodiments, each of the two sets of vibration assemblies includes a diaphragm supported on a corresponding basket frame, a magnetic circuit assembly, and a voice coil connected to the diaphragm. The magnetic circuit assembly forms the protrusion portion. The basket frame is provided with a communication hole communicating a corresponding first acoustic cavity with a side of the diaphragms of the two sets of vibration assemblies opposite thereto.

In some embodiments, a shortest distance between the pressure relief hole and the communication hole is between 0.1 mm and 3 mm.

In some embodiments, when viewed along the axial direction, the annular support assembly and an inner wall surface of the first housing close to a side of the abutment portion form a first abutting area. The two pressure relief holes are located between the first abutting area and the first end.

In some embodiments, in at least a certain area between the first abutting area and the first end, the annular support assembly and the inner wall surface of the first housing remain spaced apart, so that the two first acoustic cavities communicate with each other.

In some embodiments, the annular support assembly and an inner wall surface of the first housing away from a side of the abutment portion form a second abutting area. A second acoustic cavity is formed between the two sets of vibration assemblies. The second housing is provided with a sound outlet hole communicating the second acoustic cavity with the external environment. The sound outlet hole is located between the first abutting area and the second abutting area. The annular support assembly surrounds the sound outlet hole and abuts against the second housing to isolate the first acoustic cavity and the second acoustic cavity.

In some embodiments, when viewed along the axial direction, a shortest distance between the sound outlet hole and any one of the pressure relief holes is between 8.5 mm and 14 mm.

In some embodiments, the elastic connecting portion further includes a third housing. The third housing is assembled with the first end of the first housing. The two pressure relief holes are arranged in a strip shape. A seam line between the third housing and the first housing is equidistant from long edges of the two pressure relief holes.

In some embodiments, the earphone includes a microphone. The microphone is disposed in the third housing. The third housing is provided with a sound receiving hole. The sound receiving hole penetrates through the third housing to communicate with a sound collecting area of the microphone. When viewed along the axial direction, a distance between the sound receiving hole and any one of the pressure relief holes is greater than 3.5 mm.

In some embodiments, the inner wall surface of the first housing is provided with two limiting portions extending toward ends of the two protrusion portions away from each other along the axial direction. When viewed along the axial direction, the two pressure relief holes are located between the limiting portions and the first end.

In some embodiments, when the speaker assembly is inserted into the first housing, two abutting areas spaced apart from each other are formed between the annular support assembly and the inner wall surface of the first housing. When viewed along the axial direction, a spacing direction of the two abutting areas intersects the radial direction. The annular support assembly is respectively provided with slots at the two abutting areas. The inner wall surface of the first housing is respectively provided with insert blocks at the two abutting areas. The insert blocks and the slots form a plug-in fit as the speaker assembly is inserted into the first housing.

In some embodiments, the annular support assembly is respectively provided with stop blocks at the two abutting areas. The insert blocks and the stop blocks form a stop fit as the speaker assembly is inserted into the first housing, so as to limit an insertion depth of the speaker assembly relative to the first housing.

In some embodiments, the annular support assembly includes a connecting ring and two basket frames. The two sets of vibration assemblies are respectively disposed on the two basket frames. The two basket frames are fixed to two ends of the connecting ring along the axial direction in an assembly manner. The slots and the stop blocks are disposed on the connecting ring.

In some embodiments, the inner wall surface of the first housing is provided with two limiting portions extending toward ends of the two protrusion portions away from each other along the axial direction. The two limiting portions respectively abut against the ends of the two protrusion portions.

In some embodiments, the inner wall surface of the first housing is respectively provided with grooves at the two abutting areas. The insert blocks are located in the grooves. The annular support assembly is partially located in the grooves. In some embodiments, the second housing is provided with a sound outlet hole. A connection line between a center of the sound generation portion and a center of the abutment portion is a first connection line. A connection line between a center of the sound outlet hole and a center of the pressure relief hole is a second connection line. An included angle between a mid-perpendicular plane of the second connection line and the first connection line is less than 30°.

The beneficial effects of the present disclosure are as follows. The sound generation portion in the earphone of the present disclosure includes the first housing, the second housing, and the speaker assembly. The speaker assembly includes the annular support assembly and the two sets of vibration assemblies. Compared with providing only one vibration assembly, providing the two sets of vibration assemblies allows an amplitude of the two sets of vibration assemblies to be approximately half an amplitude of a single vibration assembly producing sound of the same output level. Therefore, a nonlinear distortion of the earphone can be reduced. Moreover, the two sets of vibration assemblies work synchronously, displacing more air when reproducing low-frequency signals, which results in more powerful and full-bodied bass, creating a stable soundstage and improving the overall audio quality of the earphone. Additionally, the speaker assembly cooperates with the first housing and the second housing to form the two first acoustic cavities around the two protrusion portions. The two pressure relief holes on the first housing are respectively connected to the two first acoustic cavities. Thus, by providing the two pressure relief holes on the first housing, which respectively correspond to the two sets of vibration assemblies and respectively correspond to the two first acoustic cavities, the two first acoustic cavities can be respectively connected to improve the pressure relief effect of the earphone, thereby improving the sound quality of the earphone. Furthermore, compared with a design with a single elongated pressure relief hole connecting both first acoustic cavities, the use of the two pressure relief holes allows for a reduction in the size of each individual pressure relief hole, which helps enhance the structural strength of the first housing, making the first housing more robust and ultimately improving the overall structural integrity of the earphone.

### BRIEF DESCRIPTION OF THE DRAWINGS

FIG. 1 is a schematic diagram illustrating a front profile of an ear of a user according to some embodiments of the present disclosure;

FIG. 2 is a schematic diagram illustrating a three-dimensional lateral structure of an earphone according to some embodiments of the present disclosure;

FIG. 3 is a schematic diagram illustrating another three-dimensional lateral structure of the earphone shown in FIG. 2;

FIG. 4 is a schematic diagram illustrating an exploded structure of the earphone shown in FIG. 2;

FIG. 5 is a schematic diagram illustrating a cross-sectional structure of the earphone shown in FIG. 3 taken along section line A-A;

FIG. 6 is a schematic diagram illustrating a cross-sectional structure of a sound generation portion in the earphone shown in FIG. 3 taken along section line B-B;

FIG. 7 is a schematic diagram illustrating a three-dimensional structure of a speaker assembly in the earphone shown in FIG. 4;

FIG. 8 is a schematic diagram illustrating a three-dimensional structure of a first housing in the earphone shown in FIG. 4;

FIG. 9 is a schematic diagram illustrating a three-dimensional structure of some assemblies in the earphone shown in FIG. 2; and

FIG. 10 is a schematic diagram illustrating yet another three-dimensional lateral structure of the earphone shown in FIG. 2.

### DETAILED DESCRIPTION

The technical solutions in the embodiments of the present disclosure will be described clearly and completely in combination with the drawings in the embodiments of the present disclosure. Obviously, the described embodiments are only a part of the embodiments of the present disclosure, and not all of the embodiments. Based on the embodiments in the present disclosure, all other embodiments obtained by those of ordinary skill in the art without creative work shall fall within the protection scope of the present disclosure.

Reference to “embodiment” in the present disclosure means that a particular feature, structure, or characteristic described in connection with the embodiment may be included in at least one embodiment of the present disclosure. Those skilled in the art explicitly and implicitly understand that the embodiments described in the present disclosure may be combined with other embodiments.

The following is an exemplary description of an earphone, provided by way of a specific embodiment.

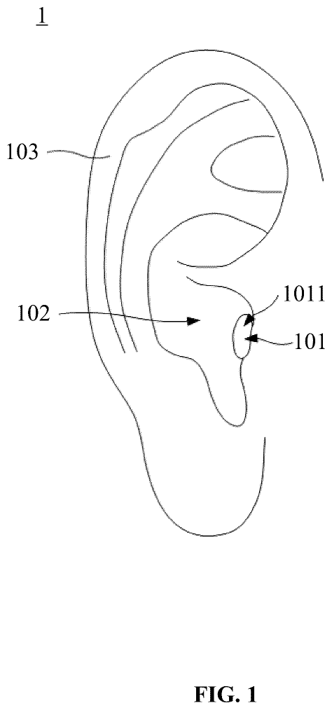

With reference to FIG. 1, an ear 1 of a user may include physiological parts such as an ear canal 101, a concha cavity 102, and an auricle 103. The ear canal 101 includes an ear canal opening 1011. The ear canal opening 1011 refers to an entrance of the ear canal 101 away from an eardrum (i.e., an ear hole). Additionally, the concha cavity 102 has a certain volume and depth. The concha cavity 102 is directly connected to the ear canal 101. That is, the aforementioned ear hole may be simply regarded as being located at a bottom of the concha cavity 102.

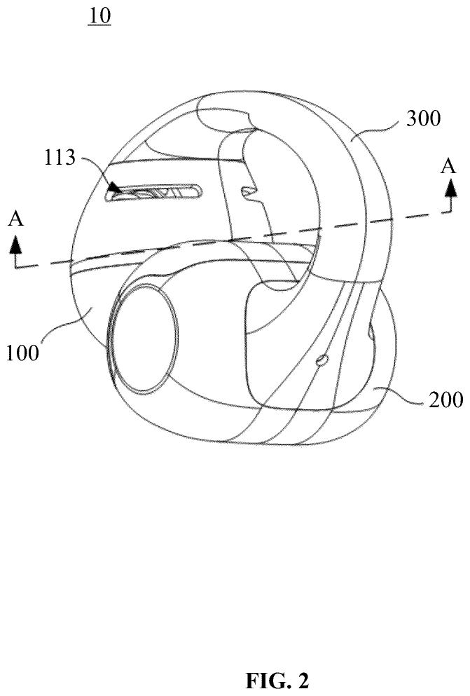

With reference to FIG. 2, an earphone 10 is an audio converter. The earphone 10 may receive an electrical signal from a media player or a receiver, and convert the electrical signal into a sound wave that may be heard by a user. In some embodiments, the earphone 10 may be an ear-clip earphone, an ear-hook earphone, a behind-the-neck earphone, etc.

In some embodiments, as shown in FIG. 2 to FIG. 10, the earphone 10 may include a sound generation portion 100, an abutment portion 200, and an elastic connecting portion 300 connected between the sound generation portion 100 and the abutment portion 200.

The sound generation portion 100 may be a sound playback device. The sound generation portion 100 may be configured to convert an electrical signal into a sound signal (also referred to as a sound wave), and propagate the sound signal to the ear 1 of a wearer.

The elastic connecting portion 300 may be an elastic element such as an elastic sheet or a spring element. The elastic connecting portion 300 may connect the sound generation portion 100 and the abutment portion 200, allowing a user to wear the earphone 10 on the ear 1 via the elastic connecting portion 300. In a wearing state, the sound generation portion 100 may be disposed in the concha cavity 102. The abutment portion 200 abuts against a back side of the auricle 103. The elastic connecting portion 300 may be wound around an outer periphery of a helix.

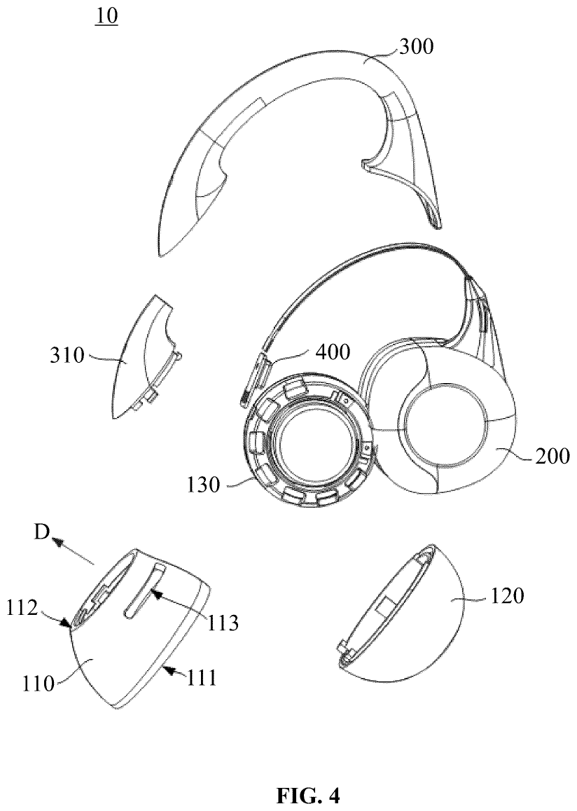

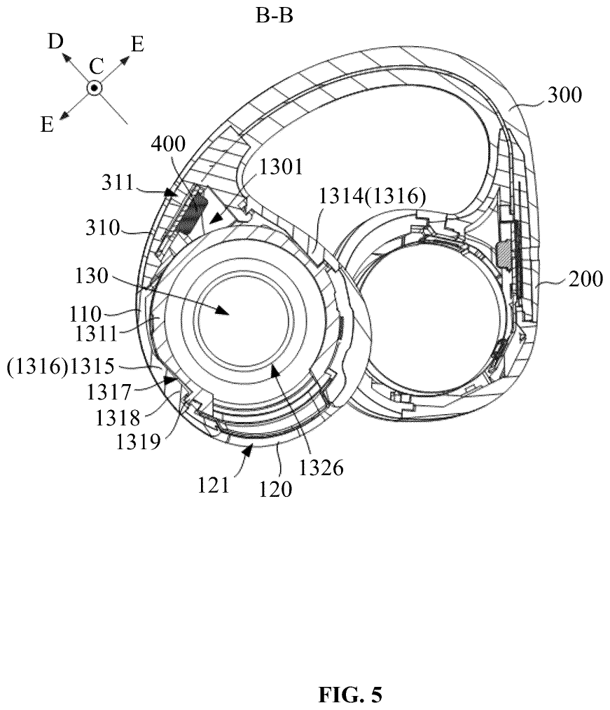

As shown in FIG. 4 and FIG. 5, the sound generation portion 100 may include a first housing 110, a second housing 120, and a speaker assembly 130. The elastic connecting portion 300 is connected to a first end 111 of the first housing 110. The first housing 110 and the second housing 120 may be engaged with each other in a snap-fit manner. The speaker assembly 130 may be disposed in a space enclosed by the first housing 110 and the second housing 120.

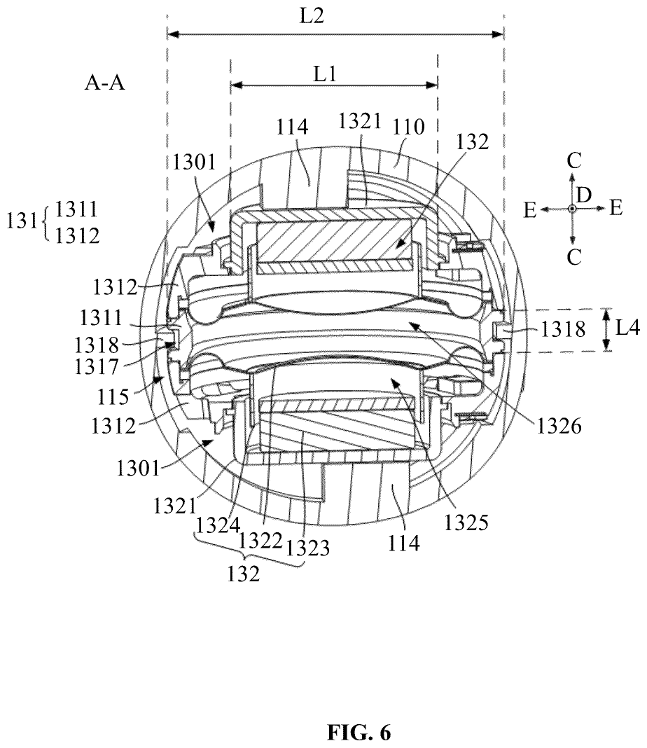

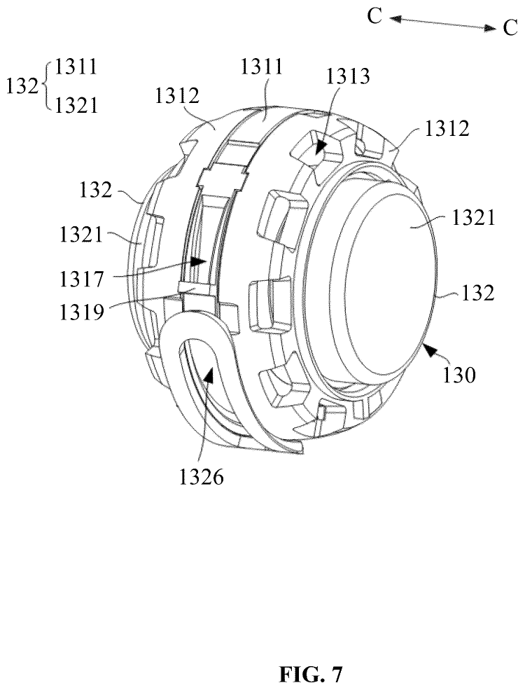

As shown in FIG. 6 and FIG. 7, the speaker assembly 130 may include an annular support assembly 131 and two sets of vibration assemblies 132 spaced apart from each other along an axial direction of the annular support assembly 131 and disposed on the annular support assembly 131. The vibration assembly 132 refers to a component that can convert an electrical signal into a corresponding sound signal. A diaphragm in the vibration assembly 132 may vibrate under an action of an electric current to generate a sound wave, which achieves a sound playback function of the sound generation portion 100. The annular support assembly 131 may connect and fix the two sets of vibration assemblies 132.

By providing the two sets of vibration assemblies 132 in the earphone 10, the two sets of vibration assemblies 132 can achieve a large diaphragm area in a relatively small space, which increases the sound quality of the earphone 10. Moreover, synchronous vibrations of the two sets of vibration assemblies 132 can increase the vibration effect at positions corresponding to the diaphragms, which makes the sound clearer and louder, and increases an upper limit of sound output of the earphone 10. Under a condition producing the same sound output level, an amplitude of each of the two sets of vibration assemblies 132 is approximately half an amplitude of a single set of vibration assembly achieving the same volume. Since a smaller amplitude leads to a reduced nonlinear distortion, the two sets of vibration assemblies deliver lower distortion at equivalent output volumes. Additionally, the synchronized operation of the two sets of vibration assemblies 132 displaces more air when reproducing low-frequency signals, which produces more powerful and full-bodied bass, helps create a stable sound stage, and ultimately contributes to superior overall sound quality for the earphone 10.

In some embodiments, the speaker assembly 130 may be partially inserted into the first housing 110 from a second end 112 of the first housing 110 along a radial direction perpendicular to the axial direction. The annular support assembly 131 abuts against an inner wall surface of the first housing 110. The second housing 120 is assembled with the second end 112 of the first housing 110. The first end 111 and the second end 112 are disposed opposite to each other. Merely by way of example, the axial direction may be a direction indicated by an arrow C in FIG. 5 and FIG. 6. A radial direction from the second end 112 of the first housing 110 toward an interior of the first housing 110 may be a direction indicated by an arrow D in FIG. 4 and FIG. 5.

As shown in FIG. 6 and FIG. 7, the two sets of vibration assemblies 132 may respectively include protrusion portions 1321 protruding beyond the annular support assembly 131 along the axial direction C and arranged opposite to each other. Radial sizes of two protrusion portions 1321 are smaller than a radial size of the annular support assembly 131. Merely by way of example, the radial size of each of the protrusion portions 1321 may be a length L1 shown in FIG. 6. The radial size of the annular support assembly 131 may be a length L2 shown in FIG. 6.

In some embodiments, in the radial direction of the speaker assembly 130, a periphery of the annular support assembly 131 extends beyond peripheries of the two protrusion portions 1321. The speaker assembly 130 abuts against the inner wall surface of the first housing 110 via the annular support assembly 131.

In some embodiments, as shown in FIG. 5 and FIG. 6, the speaker assembly 130 may cooperate with the first housing 110 and the second housing 120 to form two first acoustic cavities 1301 around the two protrusion portions 1321. The first housing 110 is provided with two pressure relief holes 113. The two pressure relief holes 113 are spaced apart from each other, each corresponds to one of the first acoustic cavities 1301 and connects the corresponding first acoustic cavity 1301 with an external environment.

In some embodiments, the two first acoustic cavities 1301 are formed around the two protrusion portions 1321 that are arranged opposite to each other along the axial direction C. Therefore, the two first acoustic cavities 1301 are spaced apart from each other along the axial direction A. The two pressure relief holes 113 on the first housing 110 are spaced apart from each other and respectively communicate with the corresponding first acoustic cavities 1301. That is, the two pressure relief holes 113 are disposed at positions of the first housing 110 corresponding to the two first acoustic cavities 1301.

With such an arrangement, it is not only convenient for the two pressure relief holes 113 to communicate with the two first acoustic cavities 1301 respectively to improve a pressure relief effect, but also the provision of the two pressure relief holes 113 allows for a higher degree of freedom in setting the pressure relief holes 113, which facilitates the opening of the pressure relief holes 113. Since the design of the pressure relief holes 113 requires a certain area, and the two sets of vibration assemblies 132 require a specific total pressure relief area, two small pressure relief holes 113, compared with one large pressure relief hole 113, are easier to design for waterproofing and dustproofing. Additionally, relatively centrally located small pressure relief holes 113, compared with one large pressure relief hole 113 located at the edge, provide higher structural strength, making the first housing 110 more robust. The arrangement also helps reduce the entry of moisture, dust, and other impurities into the first acoustic cavities 1301, thereby preventing corrosion and damage to the elements inside the first housing 110 and enhancing the reliability and durability of the earphone 10.

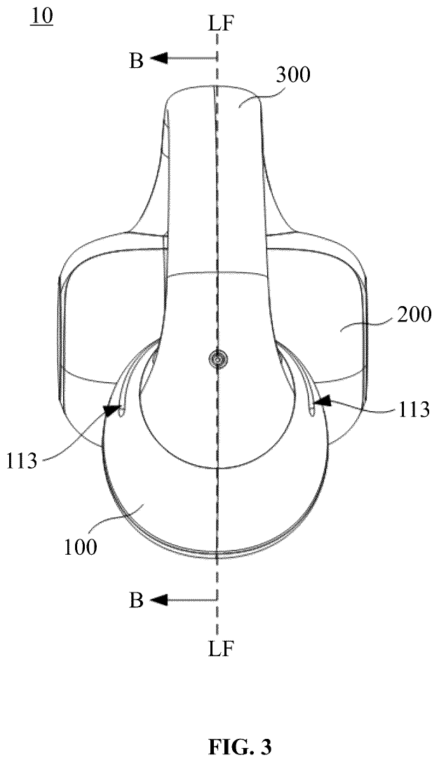

In some embodiments, as shown in FIG. 3 to FIG. 5, the annular support assembly 131 has a middle dividing plane perpendicular to the axial direction A. The two pressure relief holes 113 are spaced apart from each other on two sides of the middle dividing plane. Merely by way of example, the middle dividing plane may be LF shown in FIG. 3. FIG. 5 shows a structure of the earphone 10 in the middle dividing plane LF when viewed along the axial direction C.

The arrangement of the two pressure relief holes 113 on the two sides of the middle dividing plane LF can prevent the two pressure relief holes 113 from occupying space on the first housing 110 corresponding to the middle dividing plane LF. The arrangement allows the annular support assembly 131 to engage and abut against the first housing 110 through the area between the two pressure relief holes, or enables the placement of other elements there, thereby improving the space utilization within the first housing 110.

Moreover, arranging the two pressure relief holes 113 on the two sides of the middle dividing plane LF allows the two pressure relief holes 113 to extend from edges of the two sets of vibration assemblies 132 to central positions of the first acoustic cavities 1301 close to the vibration assemblies 132. In this way, the two pressure relief holes 113 can be closer to the central positions of the two sets of vibration assemblies 132. Consequently, the two pressure relief holes 113 can more effectively vent the respective first acoustic cavities 1301 and promote more uniform and stable vibration of the two sets of vibration assemblies 132. In addition, the arrangement helps reduce acoustic fluctuations, enhances vibrational consistency between the two sets of vibration assemblies 132, and ultimately improves the sound quality of the earphone 10.

In some embodiments, the two pressure relief holes 113 may be symmetrically arranged with respect to the middle dividing plane LF. In other words, the two pressure relief holes 113 have a same shape and are arranged at positions symmetrical to each other with respect to the middle dividing plane LF. The two sets of vibration assemblies 132 may also be arranged symmetrically with respect to the middle dividing plane LF.

With such an arrangement, the manners in which the two pressure relief holes 113 communicate with the corresponding first acoustic cavities 1301 are consistent. As a result, the pressure relief effects of the two holes can be made as identical as possible, thereby enabling the resonant peaks of the two sets of vibration assemblies 132 during sound production to be nearly the same, which serves to reduce fluctuations between the two sets of vibration assemblies 132, and consequently enhances the overall acoustic performance of the earphone 10.

In some embodiments, as shown in FIG. 6 and FIG. 7, the annular support assembly 131 may include a connecting ring 1311 and two basket frames 1312. The two sets of vibration assemblies 132 are respectively disposed on the two basket frames 1312. The two basket frames 1312 are fixed to two ends of the connecting ring 1311 along the axial direction A in an assembled manner. The connecting ring 1311 abuts against the first housing 110.

In some embodiments, the two basket frames 1312 may be disposed opposite to each other with respect to the middle dividing plane LF along the axial direction A corresponding to the two sets of vibration assemblies 132. The connecting ring 1311 is disposed at a central position between the two basket frames 1312 to connect the two basket frames 1312, which combines the two basket frames 1312 and the two sets of vibration assemblies 132 to form the speaker assembly 130. The connecting ring 1311 may abut against the first housing 110 along any radial direction perpendicular to the axial direction A, which achieves abutting fixation of the speaker assembly 130 and the first housing 110.

The arrangement of the annular support assembly 131 facilitates the preparation and assembly of the speaker assembly 130, thereby reducing the manufacturing and assembly complexity of the speaker assembly 130, which in turn lowers the overall production difficulty of the earphone 10.

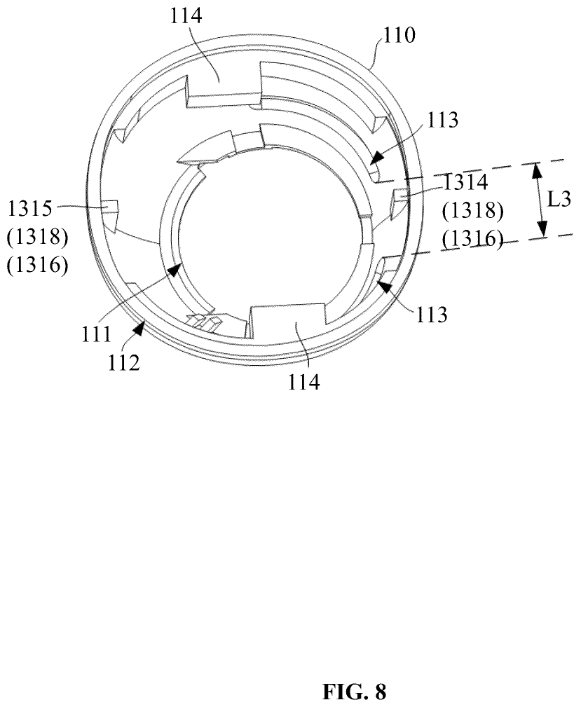

In some embodiments, a shortest spacing distance between the two pressure relief holes 113 along the axial direction A is not less than a width of the connecting ring 1311. Merely by way of example, the shortest spacing distance between the two pressure relief holes 113 along the axial direction A is shown as a distance L3 in FIG. 8, and the width of the connecting ring 1311 along the axial direction A is shown as a distance L4 in FIG. 6.

Since the connecting ring 1311 abuts against the first housing 110 along any radial direction, if the shortest spacing distance between the two pressure relief holes 113 along the axial direction A is less than the width of the connecting ring 1311, the connecting ring 1311 blocks a portion of the pressure relief holes 113 within the first housing 110, thereby affecting the pressure relief effects of the pressure relief holes 113. Furthermore, a width of the housing at a central position between the two pressure relief holes 113 being too small may result in a structural strength of the first housing 110 also being too small. When the connecting ring 1311 abuts against the housing corresponding to the central position between the two pressure relief holes 113, or when the first housing 110 is subjected to pressure, the housing at the position is prone to fracture.

Therefore, by ensuring that the shortest spacing distance between the two pressure relief holes 113 along the axial direction A is not less than the width of the connecting ring 1311, the connecting ring 1311 can't obstruct two pressure relief holes 113 within the first housing 110. The arrangement enhances the pressure relief effects of the two pressure relief holes 113. Additionally, the arrangement increases the structural strength of the housing in the central position between the two pressure relief holes 113, thereby improving the overall structural integrity of the first housing 110.

In some embodiments, as shown in FIG. 6 and FIG. 7, each of the two sets of vibration assemblies 132 includes a diaphragm 1322 supported on a corresponding basket frame 1312, a magnetic circuit assembly 1323, and a voice coil 1324 connected to the diaphragm 1322. The magnetic circuit assembly 1323 forms the protrusion portion 1321. The basket frame 1312 is provided with communication holes 1313 communicating a corresponding first acoustic cavity 1301 with a side of the diaphragms 1322 of the two sets of vibration assemblies 132 opposite thereto.

The voice coil 1324 is configured to vibrate in response to an electric current interacting with a magnetic field of the magnetic circuit assembly 1323, and to drive the diaphragm 1322 to vibrate and generate sound waves during vibration. The diaphragm 1322, the magnetic circuit assembly 1323, and the basket frames 1312 enclose to form an internal sound cavity 1325. The communication holes 1313 on the basket frames 1312 communicate the internal sound cavity 1325 with the first acoustic cavity 1301 surrounding the protrusion portion 1321.

With such an arrangement, the internal sound cavity 1325 communicates with the external environment of the earphone 10 through the communication holes 1313 on the basket frames 1312, the first acoustic cavities 1301, and the pressure relief holes 113. Air within the internal sound cavity 1325 can be effectively conducted to the outside, thereby effectively improving the pressure relief effect.

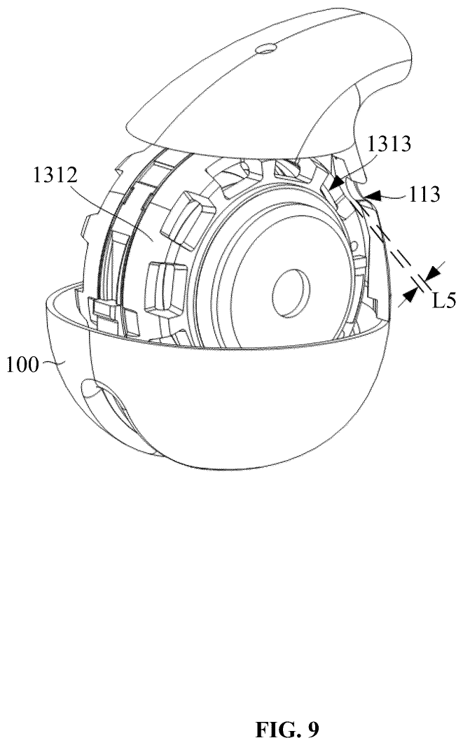

In some embodiments, as shown in FIG. 9, a shortest distance between the pressure relief hole 113 and the communication hole 1313 in between 0.1 mm and 3 mm. For example, the shortest distance between the pressure relief hole 113 and the communication hole 1313 may be 0.1 mm, 0.5 mm, 0.8 mm, 1 mm, 1.2 mm, 1.6 mm, 2 mm, 2.5 mm, 2.8 mm, or 3 mm. Merely by way of example, the shortest distance between the pressure relief hole 113 and the communication hole 1313 is shown as a distance L5 in FIG. 9.

If the shortest distance between the pressure relief hole 113 and the communication hole 1313 is set to be less than 0.1 mm, the basket frames 1312 are too close to the first housing 110, and the pressure relief holes 113 are likely to be blocked by the basket frames 1312, making it difficult to communicate with the first acoustic cavities 1301. If the shortest distance between the pressure relief hole 113 and the communication hole 1313 is set to be greater than 3 mm, the basket frames 1312 are too far from the first housing 110. The shortest distance not only increases the volume of each of the first acoustic cavities 1301, which affects the pressure relief effects of the pressure relief holes 113, but also increases the size of the earphone 10.

Therefore, arranging the shortest distance between the pressure relief hole 113 and the communication hole 1313 between 0.1 mm and 3 mm not only prevents the pressure relief holes 113 from being easily blocked by the basket frames 1312 but also reduces the volumes of the first acoustic cavities 1301, minimizing the impact on the pressure relief effects of the pressure relief holes 113 and also reducing the size of the earphone 10.

In some embodiments, as shown in FIG. 5 to FIG. 8, when viewed along the axial direction A, the annular support assembly 131 and an inner wall surface of the first housing 110 close to a side of the abutment portion 200 form a first abutting area 1314. The two pressure relief holes 113 are located between the first abutting area 1314 and the first end 111.

In some embodiments, the sound generation portion 100 includes a side close to the abutment portion 200 and a side away from the abutment portion 200. When the earphone 10 is worn, the sound generation portion 100 abuts against the concha cavity 102, while the abutment portion 200 abuts against a back side of the auricle 103. Consequently, in the wearing state, the side of the sound generation portion 100 close to the abutment portion 200 is shielded by the concha cavity 102. The first abutting area 1314 is formed on the inner wall surface of the first housing 110 on the side close to the abutment portion 200, and the two pressure relief holes 113 are arranged between the first abutting area 1314 and the first end 111. The arrangement not only positions the two pressure relief holes 113 closer to the ear 1 when the earphone 1 is in the wearing state, making it less likely for external impurities such as dust and moisture to enter the pressure relief holes 113 and damage elements inside the first housing 110, but also improves the aesthetic appearance of the earphone 10. Locating the two pressure relief holes 113 between the first abutting area 1314 and the first end 111 reduces the impact of forming the pressure relief holes 113 on the structural strength of the first housing 110, thereby reinforcing the strength of the first housing 110.

In some embodiments, in at least a certain area between the first abutting area 1314 and the first end 111, the annular support assembly 131 and the inner wall surface of the first housing 110 remain spaced apart, so that the two first acoustic cavities 1301 communicate with each other. The two first acoustic cavities 1301 communicate with the pressure relief holes 113 to achieve the pressure relief function. Therefore, arranging the two first acoustic cavities 1301 to communicate with each other, can balance the pressure relief effects of the two first acoustic cavities 1301, thereby improving the pressure relief effect.

In some embodiments, as shown in FIG. 5 and FIG. 6, the annular support assembly 131 and an inner wall surface of the first housing 110 away from a side of the abutment portion 200 form a second abutting area 1315. A second acoustic cavity 1326 is further formed between the two sets of vibration assemblies 132. The second housing 120 is provided with a sound outlet hole 121 communicating the second acoustic cavity 1326 with the external environment. The sound outlet hole 121 is located between the first abutting area 1314 and the second abutting area 1315. The annular support assembly 131 surrounds the sound outlet hole 121 and abuts against the second housing 120 to isolate the first acoustic cavity 1301 and the second acoustic cavity 1326.

In some embodiments, sound waves generated by the diaphragms 1322 of the two sets of vibration assemblies 132 may be transmitted out of the earphone 10 through the second acoustic cavity 1326 and the sound outlet hole 121. Locating the sound outlet hole 121 between the first abutting area 1314 and the second abutting area 1315 reduces the impact of forming the sound outlet hole 121 on the strength of the second housing 120, thereby reinforcing the strength of the second housing 120 and making the structure of the earphone 10 more stable.

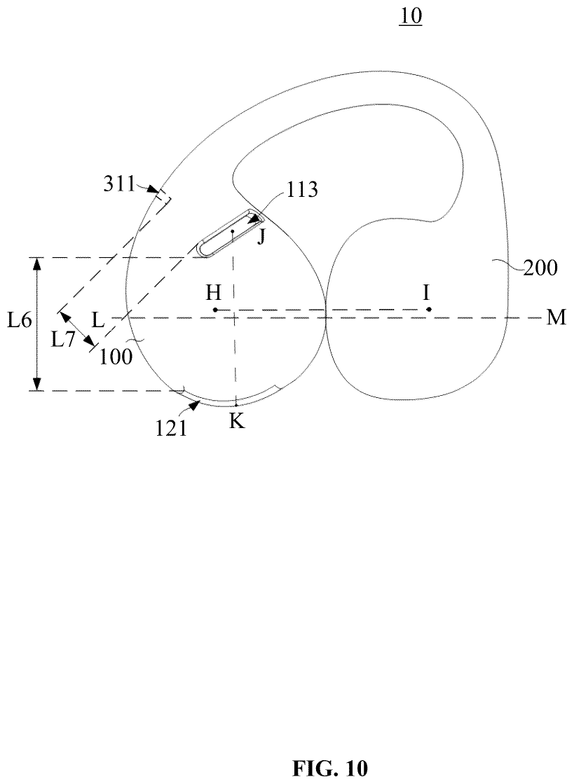

In some embodiments, as shown in FIG. 10, when viewed along the axial direction A, a shortest distance between the sound outlet hole 121 and any one of the pressure relief holes 113 is between 8.5 mm and 14 mm. For example, the shortest distance between any one of the pressure relief holes 113 and the sound outlet hole 121 may be 8.5 mm, 9 mm, 9.2 mm, 9.5 mm, 10 mm, 10.5 mm, 11 mm, 11.5 mm, 12 mm, 12.5 mm, 13 mm, or 14 mm. Merely by way of example, the shortest distance between the sound outlet hole 121 and any one of the pressure relief holes 113 is shown as a distance L6 in FIG. 10.

If the shortest distance between the sound outlet hole 121 and any one of the pressure relief holes 113 is set to be less than 8.5 mm, it indicates that a position of the pressure relief hole 113 is too close to a position of the sound outlet hole 121. Therefore, when the earphone is worn on the ear 1 of the user, the sound outlet hole 121 corresponds to the ear canal opening 1011 of the user while the pressure relief hole 113 is easily blocked by the ear 1, thereby affecting the pressure relief effect of the pressure relief hole 113. If the shortest distance between the sound outlet hole 121 and any one of the pressure relief holes 113 is set to be greater than 14 mm, it indicates that the pressure relief hole 113 is too close to an edge of the first housing 110. The arrangement affects the strength of the first housing 110, and the pressure relief hole 113 being far from a central position of the vibration assembly 132 also affects the pressure relief effect, thereby degrading the sound quality of the earphone 10.

Therefore, by arranging the shortest distance between the sound outlet hole 121 and any one of the pressure relief holes 113 between 8.5 mm and 14 mm, the pressure relief hole 113 is less likely to be obstructed by the ear 1, the impact of the pressure relief hole 113 on the structural strength of the first housing 110 is minimized, and the pressure relief effect of the pressure relief hole 113 is enhanced to improve the sound quality of the earphone 10.

In some embodiments, as shown in FIG. 4, the elastic connecting portion 300 further includes a third housing 310. The third housing 310 is assembled with the first end 111 of the first housing 110. The two pressure relief holes 113 are arranged in a strip shape, and a seam line between the third housing 310 and the first housing 110 is equidistant from long hole edges of the two pressure relief holes 113.

In some embodiments, when viewed along the axial direction A, long sides of the two pressure relief holes 113 are parallel to the seam line between the third housing 310 and the first housing 110. Arranging the shape of the two pressure relief holes 113 in this manner reinforces the strength between the long sides of the two pressure relief holes 113 and the first end 111 of the first housing 110, thereby enhancing the structural strength of the first housing 110. Furthermore, the arrangement allows the two independently arranged pressure relief holes 113 to be closer to the communication holes 1313 on the basket frames 1312 at the back of the vibration assembly 132. Consequently, the resonant peak of the first acoustic cavity 1301 is shifted to a higher frequency, which results in a flatter frequency response and reduced phase fluctuation across a wider bandwidth for the sound output from the entire first acoustic cavity 1301, thereby contributing to reduced sound leakage for the earphone 10.

Certainly, in other embodiments, the shape of the pressure relief holes 113 may also be circular, triangular, irregular, etc.

In some embodiments, as shown in FIG. 4 and FIG. 5, the earphone 10 includes a microphone 400. The microphone 400 is disposed in the third housing 310. The third housing 310 is provided with a sound receiving hole 311. The sound receiving hole 311 penetrates through the third housing 310 to communicate with a sound collecting area of the microphone 400. The microphone 400 is configured to collect an external sound of the earphone 10 via the sound receiving hole 311. For example, the external sound of the earphone 10 includes a speech of a user, a horn sound, a bicycle bell sound, surrounding human voices, or traffic command sounds.

As shown in FIG. 10, when viewed along the axial direction A, a distance between the sound receiving hole 311 and any one of the pressure relief holes 113 is greater than 3.5 mm. For example, when viewed along the axial direction A, a distance between the sound receiving hole 311 and any one of the pressure relief holes 113 is 3.8 mm, 4 mm, 4.5 mm, 5 mm, 5.5 mm, 6 mm, 6.5 mm, 8 mm, or 10 mm. Merely by way of example, the shortest distance between the sound outlet hole 121 and any one of the pressure relief holes 113 is shown as a distance L7 in FIG. 10.

If the distance between the sound receiving hole 311 and any one of the pressure relief holes 113 is set to be less than 3.5 mm, it indicates that the distance between the sound receiving hole 311 and any one of the pressure relief holes 113 is small. Consequently, the microphone 400 disposed at the sound receiving hole 311 is likely to extend from the third housing 310 into an interior of the first housing 110, thereby easily blocking the pressure relief hole(s) 113 and affecting the pressure relief effect(s) of the pressure relief hole(s) 113.

Therefore, arranging the distance between the sound receiving hole 311 and any one of the pressure relief holes 113 to be greater than 3.5 mm prevents the pressure relief hole(s) 113 from being easily blocked by the ear 1, thereby improving the pressure relief effects of the pressure relief holes 113 and enhancing the sound quality of the earphone 10.

In some embodiments, as shown in FIG. 6 and FIG. 8, the inner wall surface of the first housing 110 is provided with two limiting portions 114 extending toward ends of the two protrusion portions 1321 away from each other along the axial direction A. When viewed along the axial direction A, the two pressure relief holes 113 are located between the limiting portions 114 and the first end 111. Arranging the two pressure relief holes 113 between the limiting portions 114 and the first end 111 reduces the impact of forming the two pressure relief holes 113 on the first housing 110, thereby improving the structural strength of the first housing 110.

In some embodiments, as shown in FIG. 6, the two limiting portions 114 abut against ends of the two protrusion portions 1321, respectively. In some embodiments, the two limiting portions 114 may abut against the two protrusion portions 1321 in the axial direction A, respectively, thereby limiting the speaker assembly 130 in the axial direction A, which may enhance the structural stability inside the first housing 110 and the structural strength of the first housing 110.

In some embodiments, as shown in FIG. 5 and FIG. 8, when the speaker assembly 130 is inserted into the first housing 110, two abutting areas 1316 spaced apart from each other are formed between the annular support assembly 131 and the inner wall surface of the first housing 110.

In some embodiments, the two abutting areas 1316 may be the first abutting area 1314 and the second abutting area 1315.

When viewed along the axial direction A, a spacing direction of the two abutting areas 1316 intersects with the radial direction D. In other words, a direction in which the speaker assembly 130 is inserted into the first housing 110 intersects with the spacing direction of the two abutting areas 1316. Merely by way of example, the spacing direction of the two abutting areas 1316 may be a direction indicated by an arrow E in FIG. 5 and FIG. 6.

As shown in FIG. 5 to FIG. 8, the annular support assembly 131 may be provided with slots 1317 at the two abutting areas 1316, respectively. The inner wall surface of the first housing 110 is provided with insert blocks 1318 at the two abutting areas 1316, respectively. The insert blocks 1318 and the slots 1317 form a plug-in fit as the speaker assembly 130 is inserted into the first housing 110. That is, in other words, during a process of inserting the speaker assembly 130 into the first housing 110 along the radial direction D, the insert blocks 1318 on the inner wall surface of the first housing 110 and the slots 1317 of the annular support assembly 131 may achieve the plug-in fit, thereby achieving limited abutment between the annular support assembly 131 and the first housing 110.

Since the two pressure relief holes 113 are disposed on two sides of the speaker assembly 130 along the axial direction C of the first housing 110, arranging the two abutment areas 1316 along the radial direction ensures that the abutment areas 1316 and the pressure relief holes 113 do not interfere with each other. The arrangement allows that the speaker assembly 130 and the first housing 110 can reliably abut and be fixed even if the positions of the two pressure relief holes 113 are adjusted, thereby improving the structural stability inside the earphone 10.

In some embodiments, as shown in FIG. 5 and FIG. 7, the annular support assembly 131 is provided with stop blocks 1319 at the two abutting areas 1316, respectively. The insert blocks 1318 and the stop blocks 1319 form a stop fit as the speaker assembly 130 is inserted into the first housing 110, so as to limit an insertion depth of the speaker assembly 130 relative to the first housing 110.

The stop blocks 1319 are arranged at one end of the slots 1317. The insert blocks 1318 and the stop blocks 1319 may engage with each other in the stop fit, thereby preventing the speaker assembly 130 from rotating circumferentially within a plane defined by the radial direction D inside the first housing 110. The slots 1317 are configured to limit movement of the speaker assembly 130 along the axial direction A, thereby further fixing the speaker assembly 130 inside the first housing 110.

Furthermore, the stop blocks 1319 and the slots 1317 may cooperate with each other, so that a depth of the slots 1317 is the insertion depth of the speaker assembly 130 relative to the first housing 110. When the speaker assembly 130 is inserted into the first housing 110, the insert blocks 1318 are inserted into the slots 1317 and form the plug-in fit. When the insert blocks 1318 abut the stop blocks 1319, a process of fitting and assembling the speaker assembly 130 with the first housing 110 is completed. The arrangement may facilitate insertion of the speaker assembly 130 into the first housing 110, thereby simplifying an assembly process of the earphone 10.

In some embodiments, as shown in FIG. 6 and FIG. 7, the two sets of vibration assemblies 132 may be disposed on the two basket frames 1312, respectively. The two basket frames 1312 may be fixed to two ends of the connecting ring 1311 along the axial direction C in an assembled manner. The slots 1317 and the stop blocks 1319 are disposed on the connecting ring 1311.

In some embodiments, the two sets of vibration assemblies 132 are disposed on the two basket frames 1312. The connecting ring 1311 connects and fixes the two basket frames 1312 to connect and fix the two sets of vibration assemblies 132. By arranging the insertion slots 1317 and the stop blocks 1319 on the connecting ring 1311, it not only facilitates the fabrication and formation of the insertion slots 1317 and the stop blocks 1319, simplifying the structure of the speaker assembly 130, but also makes it easier to achieve mutual abutment and fixation between the speaker assembly 130 and the first housing 110. The arrangement consequently simplifies the fixed connection structure between the speaker assembly 130 and the first housing 110.

In some embodiments, as shown in FIG. 6, the inner wall surface of the first housing 110 may be provided with grooves 115 at the two abutting areas 1316, respectively. The insert blocks 1318 are located in the grooves 115. The annular support assembly 131 is partially located in the grooves 115.

In some embodiments, a shape of the grooves 115 corresponds to a shape of a portion of a periphery of the annular support assembly 131 in the radial direction. During the process of inserting the speaker assembly 130 into the first housing 110, the portion of the periphery of the annular support assembly 131 cooperates with the grooves 115 to be inserted into the grooves 115, and the insert blocks 1318 are also inserted into the slots 1317. By arranging the grooves 115, it is possible to facilitate positioning of the annular support assembly 131 during the assembly process, thereby facilitating assembly of the speaker assembly 130 with the first housing 110. Furthermore, the first housing 110 may further limit the position of the annular support assembly 131 through the grooves 115, thereby further fixing the speaker assembly 130 to improve the structural stability of the earphone 10.

In some embodiments, as shown in FIG. 10, the second housing 120 is provided with a sound outlet hole 121. A connection line between a center of the sound generation portion 100 and a center of the abutment portion 200 is a first connection line. A connection line between a center of the sound outlet hole 121 and a center of the pressure relief hole 113 is a second connection line. An included angle between a mid-perpendicular plane of the second connection line and the first connection line is less than 30°. Merely by way of example, the first connection line may be a line segment HI shown in FIG. 10, the second connection line may be a line segment JK shown in FIG. 10, and the mid-perpendicular plane of the second connection line JK may be a plane LM shown in FIG. 10.

For example, in some embodiments, the included angle between the mid-perpendicular plane LM of the second connection line JK and the first connection line HI may be 0°, 10°, 15°, 20°, or 25°, etc.

The second connection line JK is perpendicular to the mid-perpendicular plane LM of the second connection line JK, and the mid-perpendicular plane LM bisects the second connection line JK. In some embodiments, the mid-perpendicular plane LM is a sound cancellation surface formed by the sound outlet hole 121 and the pressure relief hole 113. On this surface, sound waves from the sound outlet hole 121 and the pressure relief hole 113 cancel each other out. Therefore, when the earphone 10 is worn on the ear 1, the mid-perpendicular plane LM needs to be kept away from the ear canal opening 1011 as soon as possible.

In the wearing state, since the sound generation portion 100 may be arranged in the concha cavity 102 and the abutment portion 200 abuts against the back side of the auricle 103, the first connection line HI may be parallel to a thickness direction of the auricle 103 and substantially perpendicular to an orientation direction of the ear canal opening 1011. The thickness direction of the auricle 103 may be substantially perpendicular to the orientation direction of the ear canal opening 1011. Due to differences in the structures of the ears 1 of different human bodies and the influence of different wearing manners when the earphone 10 is worn on the ear 1, “the first connection line HI is parallel to the thickness direction of the auricle 103” means that a spatial angle between the first connection line HI and the thickness direction of the auricle 103 is less than 10°. “The first connection line HI is substantially perpendicular to the orientation direction of the ear canal opening 1011” means that a spatial angle between the first connection line HI and the orientation direction of the ear canal opening 1011 between 80° and 100°.

Therefore, it may be concluded that by arranging the included angle between the mid-perpendicular plane LM of the second connection line JK and the first connection line to be less than 30°, the mid-perpendicular plane LM of the first connection line HI forms a sufficiently large spatial angle with the orientation direction of the ear canal opening 1011. The arrangement positions the mid-perpendicular plane LM farther away from the ear canal opening 1011, thereby reducing the detrimental impact of acoustic phase cancellation (caused by the interaction between the sound outlet hole 121 and the pressure relief hole 113) on the sound quality transmitted into the ear canal of the user, ultimately improving the listening experience.

In summary, the sound generation portion in the earphone of the present disclosure includes the first housing 110, the second housing 120, and the speaker assembly 130. The speaker assembly 130 includes the annular support assembly 131 and the two sets of vibration assemblies 132. The provision of the two sets of vibration assemblies 132, compared with providing only one vibration assembly 132, allows an amplitude of the two sets of vibration assemblies 132 to be approximately half an amplitude of a single vibration assembly 132 that output a sound of the same magnitude. Therefore, nonlinear distortion of the earphone 10 can be reduced. Furthermore, the two sets of vibration assemblies 132 operate synchronously. When playing low-frequency signals, the two sets of vibration assemblies 132 can push more air, making the low frequencies more powerful and full, and can create a stable sound field, resulting in better sound quality for the earphone 10. Moreover, the speaker assembly 130 cooperates with the first housing 110 and the second housing 120 to form the two first acoustic cavities 1301 around the two protrusion portions 1321. The two pressure relief holes 113 on the first housing 110 communicate with the two first acoustic cavities 1301, respectively. Thus, by providing the two pressure relief holes 113 on the first housing 110, the two pressure relief holes 113 correspond to the two sets of vibration assemblies 132 respectively and the two first acoustic cavities 1301 respectively. The arrangement not only individually vents the two first acoustic cavities 1301, enhancing the pressure relief effect of the earphone 10 and thereby improving the sound quality of the earphone 10, but also, compared with a design using a single elongated pressure relief hole 113 to connect the two first acoustic cavities, allows for a reduction in the size of each individual pressure relief hole. The arrangement contributes to higher structural strength of the first housing 110, making the first housing 110 more robust.

The foregoing embodiments are merely illustrative and are not intended to limit the patent scope of the present disclosure. Any equivalent structure or equivalent process transformation made based on the content of the present disclosure and the accompanying drawings, or direct or indirect application in other related technical fields, shall similarly be included within the patent protection scope of the present disclosure.

What is claimed is:

1. An earphone, comprising a sound generation portion, an abutment portion, and an elastic connecting portion connected between the sound generation portion and the abutment portion, wherein in a wearing state, the sound generation portion is disposed in a concha cavity, the abutment portion abuts against a back side of an auricle, and the elastic connecting portion is wound around an outer periphery of a helix, wherein
the sound generation portion comprises a first housing, a second housing, and a speaker assembly, and the elastic connecting portion is connected to a first end of the first housing;
the speaker assembly comprises an annular support assembly and two sets of vibration assemblies spaced apart from each other along an axial direction of the annular support assembly and disposed on the annular support assembly, wherein the annular support assembly comprises a connecting ring and two basket frames, and the two sets of vibration assemblies are respectively disposed on the two basket frames;
the two sets of vibration assemblies respectively include protrusion portions protruding beyond the annular support assembly along the axial direction and arranged opposite to each other;
the speaker assembly cooperates with the first housing and the second housing to form two first acoustic cavities around two protrusion portions; and
the first housing is provided with two pressure relief holes, wherein the two pressure relief holes are spaced apart from each other, each corresponds to one of the first acoustic cavities and connects the corresponding first acoustic cavity with an external environment.

2. The earphone of claim 1, wherein
the speaker assembly is partially inserted into the first housing from a second end of the first housing along a radial direction perpendicular to the axial direction;
the annular support assembly abuts against an inner wall surface of the first housing;
the second housing is assembled with the second end of the first housing, and the first end and the second end are arranged opposite to each other;
radial sizes of the two protrusion portions are smaller than a radial size of the annular support assembly;
the annular support assembly has a middle dividing plane perpendicular to the axial direction; and
the two pressure relief holes are spaced apart from each other on two sides of the middle dividing plane.

3. The earphone of claim 2, wherein the two pressure relief holes are symmetrically arranged with respect to the middle dividing plane.

4. The earphone of claim 1, wherein
the two basket frames are fixed to two ends of the connecting ring along the axial direction in an assembled manner; and
the connecting ring abuts against the first housing.

5. The earphone of claim 4, wherein a shortest spacing distance between the two pressure relief holes along the axial direction is not less than a width of the connecting ring.

6. The earphone of claim 4, wherein each of the two sets of vibration assemblies comprises:
a diaphragm supported on a corresponding basket frame;
a magnetic circuit assembly; and
a voice coil connected to the diaphragm, wherein the magnetic circuit assembly forms the protrusion portion, the basket frame is provided with communication holes communicating a corresponding first acoustic cavity with a side of the diaphragms of the two sets of vibration assemblies opposite thereto.

7. The earphone of claim 6, wherein a shortest distance between the pressure relief hole and the communication hole is between 0.1 mm and 3 mm.

8. The earphone of claim 1, wherein when viewed along the axial direction,
the annular support assembly and an inner wall surface of the first housing close to a side of the abutment portion form a first abutting area; and
the two pressure relief holes are located between the first abutting area and the first end.

9. The earphone of claim 8, wherein in at least a certain area between the first abutting area and the first end, the annular support assembly and the inner wall surface of the first housing remain spaced apart, so that the two first acoustic cavities communicate with each other.

10. The earphone of claim 8, wherein
the annular support assembly and an inner wall surface of the first housing away from a side of the abutment portion form a second abutting area;
a second acoustic cavity is formed between the two sets of vibration assemblies;
the second housing is provided with a sound outlet hole communicating the second acoustic cavity with the external environment;
the sound outlet hole is located between the first abutting area and the second abutting area; and
the annular support assembly surrounds the sound outlet hole and abuts against the second housing to isolate the first acoustic cavity and the second acoustic cavity.

11. The earphone of claim 10, wherein when viewed along the axial direction, a shortest distance between the sound outlet hole and any one of the pressure relief holes is between 8.5 mm and 14 mm.

12. The earphone of claim 1, wherein the elastic connecting portion further comprises a third housing, wherein
the third housing is assembled with the first end of the first housing;
the two pressure relief holes are arranged in a strip shape; and
a seam line between the third housing and the first housing is equidistant from long edges of the two pressure relief holes.

13. The earphone of claim 12, wherein the earphone comprises a microphone, wherein
the microphone is disposed in the third housing;
the third housing is provided with a sound receiving hole;
the sound receiving hole penetrates through the third housing to communicate with a sound collecting area of the microphone; and
when viewed along the axial direction, a distance between the sound receiving hole and any one of the pressure relief holes is greater than 3.5 mm.

14. The earphone of claim 1, wherein
the inner wall surface of the first housing is provided with two limiting portions extending toward ends of the two protrusion portions away from each other along the axial direction; and
when viewed along the axial direction, the two pressure relief holes are located between the limiting portions and the first end.

15. The earphone of claim 1, wherein
the speaker assembly is partially inserted into the first housing from a second end of the first housing along a radial direction perpendicular to the axial direction;
when the speaker assembly is inserted into the first housing, two abutting areas spaced apart from each other are formed between the annular support assembly and the inner wall surface of the first housing;
when viewed along the axial direction, a spacing direction of the two abutting areas intersects with the radial direction;
the annular support assembly is respectively provided with slots at the two abutting areas;
the inner wall surface of the first housing is respectively provided with insert blocks at the two abutting areas; and
the insert blocks and the slots form a plug-in fit as the speaker assembly is inserted into the first housing.

16. The earphone of claim 15, wherein
the annular support assembly is respectively provided with stop blocks at the two abutting areas; and
the insert block and the stop block form a stop fit as the speaker assembly is inserted into the first housing, so as to limit an insertion depth of the speaker assembly relative to the first housing.

17. The earphone of claim 16, wherein
the annular support assembly comprises a connecting ring and two basket frames;
the two sets of vibration assemblies are respectively disposed on the two basket frames;
the two basket frames are fixed to two ends of the connecting ring along the axial direction in an assembled manner; and
the slots and the stop blocks are disposed on the connecting ring.

18. The earphone of claim 17, wherein the inner wall surface of the first housing is provided with two limiting portions extending toward ends of the two protrusion portions away from each other along the axial direction, wherein the two limiting portions respectively abut against the ends of the two protrusion portions.

19. The earphone of claim 17, wherein
the inner wall surface of the first housing is respectively provided with grooves at the two abutting areas;
the insert blocks are located in the grooves; and
the annular support assembly is partially located in the grooves.

20. The earphone of claim 1, wherein
the second housing is provided with a sound outlet hole;
a connection line between a center of the sound generation portion and a center of the abutment portion is a first connection line;
a connection line between a center of the sound outlet hole and a center of the pressure relief hole is a second connection line; and
an included angle between a mid-perpendicular plane of the second connection line and the first connection line is less than 30°.
